(19) United States
(12) Patent Application Publication
(10) Pub. No.: US 2016/0232112 A1
(43) Pub. Date: Aug. 11, 2016

(54) Unified Memory Bus and Method to Operate the Unified Memory Bus

(71) Applicant: Futurewei Technologies, Inc., Plano, TX (US)

(72) Inventor: Xiaobing Lee, Santa Clara, CA (US)

(21) Appl. No.: 15/017,522

(22) Filed: Feb. 5, 2016

Related U.S. Application Data
(60) Provisional application No. 62/113,242, filed on Feb. 6, 2015.

(51) Int. Cl. G06F 13/16; G06F 13/40; G06F 3/06

(52) U.S. Cl. CPC G06F 13/1673; G06F 3/0622; G06F 3/0659; G06F 3/0685; G06F 13/4068; G06F 3/0604; G06F 3/064

(57) ABSTRACT

A system including an unified memory interface (UMI) data bus and a method for operating the UMI bus are disclosed. In an embodiment, the system includes a UMI bus, a processor coupled to the UMI bus, a RAM/NVM device coupled to the UMI bus and NVM/SSD devices coupled to the UMI bus, wherein the UMI bus is configured to use RAM/NVM device random access waiting cycles to block access the NVM/SSD devices.

This application claims the benefit of U.S. Provisional Application No. 62/113,242, filed on Feb. 6, 2015, which application is hereby incorporated herein by reference.

### TECHNICAL FIELD

The present invention relates to storage technology, and, in particular embodiments, to systems and methods for unified memory controlling, cache clustering, and networking for storage system-on-a-chip (SoC) and central processing units (CPUs).

### BACKGROUND

Current double data rate 4 (DDR4) buses cannot properly support mixed DDR4-dynamic random access memory (DRAM) devices, non-volatile memory (NVM) devices and flash memory devices. Current SoC's and CPU's DDR4 buses have low utilization (too much waiting time) to access Flash or NVM devices by single rank controls. There are fewer bus slots for single-port memory devices with limited memory capacity, low data reliability and system availability.

### SUMMARY

In accordance with an embodiment, a system comprises a unified memory interface (UMI) bus, a CPU coupled to the UMI bus, a RAM/NVM device coupled to the UMI bus and NVM/SSD devices coupled to the UMI bus, wherein the UMI bus is configured to use RAM/NVM device random access waiting cycles to block access the NVM/SSD devices.

In accordance with another embodiment, a method comprises performing a first memory write to a data buffer region of a memory buffer, during the first memory write, receiving a first write command with CMD descriptors to initiate a block memory write to a NAND/NVM device at a CMD region of the memory buffer and performing the block memory write to transfer data from the data buffer region to a NAND/NVM page according to the first write command. The method further comprises polling for a NAND/NVM page write completion status from a NAND/NVM status register, setting the write completion status or an error message at a status region of the memory buffer to inform a host about a NAND/NVM status and during the block memory write, performing a second memory write to the data buffer region.

In accordance with a yet another embodiment, a system includes DDR4 bus expansion segments for clustering low cost DDR4-DRAM devices and DDR4-SSD devices for higher memory capacities and better bus utilizations. The DDR4 bus expansion segments may support a dual-port DDR4 bus for high system reliability and availability, including multi-chassis scalability and data mirroring ability.

In accordance with a further embodiment, a method for operating a system, wherein a united memory interface (UMI) bus connects a CPU with a dual port DRAM, and wherein the DRAM is connected to a NVM or flash NAND controller, the method includes writing, by the CPU, NVM/SSD controller to a CMD region of the dual port DRAM, reading, by the NVM/SSD controller, the NVM commands from the CMD region, writing, by the NVM/SSD controller, data blocks into a data buffer region of the dual port DRAM, writing, by the NVM/SSD controller, the data blocks in a status region of the dual port DRAM and polling, by the CPU, the data blocks from the status region.

In accordance with yet a further embodiment, a method for controlling an unified memory bus includes performing command/data/statue accesses of a DDR4-DRAM buffer for a block data transport (DDR4-T) protocol. The method includes, issuing a command to initiate a block memory access of a flash or NVM device at first, then transferring block data between the DDR4-DRAM buffer and the flash/NVM devices, and after completing the command execution, marking the status as complete. The method further includes, issuing multiple command/data/statue queues to initiate multiple memory accesses of the Flash or NVM devices, interleaving the block data transfers, and after completing each block command executions, marking statues as complete so to inform the SoC or CPU.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1A illustrates a system of UMI buses operating DDR4-DRAM DIMMs and dual-port DDR4-SSD DIMMs according to an embodiment;

FIG. 1B illustrates a system of an UMI bus supporting two groups of DDR4-AFA DIMMs according to an embodiment. The DDR4 AFA DIMMs may be dual-port DDR4-AFA DIMMs;

FIG. 1C illustrates a system of an UMI bus supporting three groups of DDR4 AFA DIMMs according to an embodiment. The DDR4 AFA DIMMs may be dual-port DDR4-AFA DIMMs;

FIG. 1D illustrates a system of an UMI supporting DDR4-DRAM DIMMs, DDR4-NVM DIMMs, and DDR4-SSD DIMMs according to an embodiment. The UMI may comprise 1 to 3 bus expansions;

FIG. 1E illustrates a system of an UMI supporting DDR4-DRAM DIMMs, DDR4-NVM DIMMs, and DDR4-SSD DIMMs according to an embodiment. The UMI may comprise 1 to 4 bus expansions;

FIG. 2 illustrates operating an UMI bus by inserting DDR4-SSD block accesses in DRAM bus waiting cycles to interleaving a DDR4 random access protocol and a DDR4-T block access protocol, according to an embodiment;

FIG. 3A illustrates a system, wherein the CPU controls an SSD controller through a shared DRAM according to an embodiment;

FIGS. 3B and 3C illustrate a read operation scheme and a write operation scheme according to an embodiment;

FIG. 3D illustrates a NVM/SSD controller according to an embodiment;

FIGS. 3E and 3F illustrate a select table and a refreshing command table;

FIGS. 4A-4D illustrate a system comprising a CPU and a dual port DDR4-SSD with dual-port NVM/DRAM(s), The dual port NVM/DRAM(s) are shared by the CPU and the flash control according to an embodiment;

FIG. 5A illustrates a system comprising two CPUs supporting four DDR4-DRAM channels and four UMI channels, wherein each 64 bit UMI channel splits into 8-channels of 8 bit DDR4-ONFI channels for clustering 16 DDR4-AFA DIMMs according to an embodiment;

FIG. 5B illustrates a system comprising two CPUs supporting 8 UMI channels to cluster 8 DDR4-DRAM and 64 DDR4-SSD devices according to an embodiment;

FIGS. 6A and 6B illustrate a system comprising a 64 bit UMI bus connected to DDR4-DRAM DIMMs and 16 DDR4-ONFI SSD DIMMs according to an embodiment;

FIG. 6C illustrates a 64 bit UMI bus having a MUX ping-ponging between DRAM-mode and flash-mode according to an embodiment; and

FIGS. 7A and 7B illustrate a system comprising DRAM buffer chips on a DDR4-SSD device mapped to host VM space for access by PCIe I/O devices according to an embodiment.

### DETAILED DESCRIPTION OF ILLUSTRATIVE EMBODIMENTS

The structure, manufacture and use of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

Double data rate 4 (DDR4) dual inline memory modules (DIMMs) and non-volatile memory DIMMs (NVM DIMMs) are emerging. Many new memory media are also emerging. A few examples are phase change random access memory (PCRAM), spin torque transfer random access memory (STT-MRAM), 3D-X Point memory, and resistive random access memory (ReRAM).

Conventional DDR4 dynamic random access memory (DDR4-DRAM) bus utilization is about sixty percent (60%) for 3-DIMMs per bus random read/write BL8 (64 Bytes cache line) by 2400MT/s chips with a CL=16 clock latency, and less than forty percent (40%) by 3200MT/s chips with a CL=24 clock latency by 2-rank controls.

Current non-volatile memory (NVM) technologies such as STT-MRAM technology and ReRAM technology generally do not support DDR4 speed. Some chips may be improved for the DDR3 or DDR4 speed but with various (shorter or longer) read/write latencies.

Embodiments of the invention mix standard DDR4-DRAM devices/DIMMs with DDR4-NVM devices/DIMMs and DDR4-SSD devices/DIMMs and by properly operating these devices, the utilization of an unified memory interface (UMI) bus can be greatly improved.

Various embodiments of the invention provide a unified memory interface (UMI) bus that supports a mix of high performance DDR4-DRAM devices/DIMMs, high capacity DDR4-NVM devices/DIMMs, and DDR4-SSD devices/blocks or DIMMs such that the UMI bus utilization is improved. Benefits of various embodiments may include reduced storage cost.

The utilization of an UMI bus may be improved by inserting SSD/NVM block burst read/write operations between RAM/NVM random read-write operation waiting time slots. Such a UMI bus operation may efficiently interleave different types of memory operation cycles. By stealing bus cycles while waiting for DRAM random read-write accesses, NVM/SSD block read/write data transfers may be carried out. In some embodiments, this can be achieved by inserting a DDR4-NVM/SSD burst block read/write access in a DDR4-DRAM control and data-ready waiting cycles. Such a method may improve the UMI bus utilization to about eighty five percent (85%) or better, ninety percent (90%) or better, or ninety five percent (95%) or better from currently sixty percent (60%) or forty percent (40%).

Another advantage may include enhancing the memory bus fan-out capacity by controlling more DDR4-NVM/SSD devices via that bus. For example, a 64 bit UMI bus may operate 24 (3×8 of 8 bit) DDR4-SSD DIMMs. A further advantage may include minimizing DMA/rDMA bus overhead by allowing PCIe I/O to directly access DRAM buffer chips located on a DDR4-NVM/SSD DIMM. Moreover, mixing a standard DDR4-DRAM DIMM with 8-channels of 8-bit DDR4-SSD DIMMs may significantly increase the memory bus fan-out capability, thus reducing system costs.

Various embodiments include dual-port DDR4-SSD DIMMs linked to two processors (SoCs/CPUs). This includes the benefit of enhanced reliability of DDR4-SSD DIMM. For example, when one CPU or an attached network link has trouble, the other CPU can still access the data. This may provide a primary storage system without single point failing components/devices. Moreover, this may include the benefit of enhanced AFA clusters availability with few failed CPUs or nodes by erasure coding protections.

Some embodiments provide a method for low latency accessing 3D-XP devices during DRAM refreshing commands to pass DDR4 T commands and controls to the 3D-XP controller through the UMI bus. The 3D-XP devices may be read or write during normal DRAM access commands at proper timing.

A DDR4 unified memory interface (UMI) DDR 4 bus according to embodiments may include one or more of the following aspects.

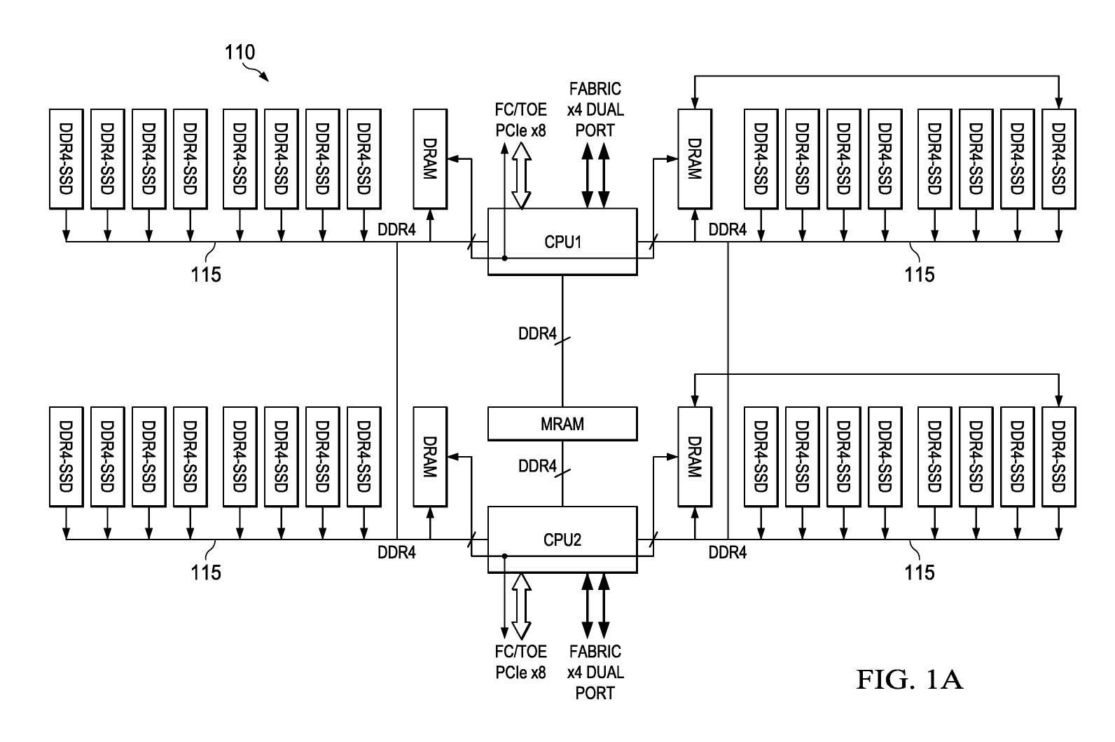

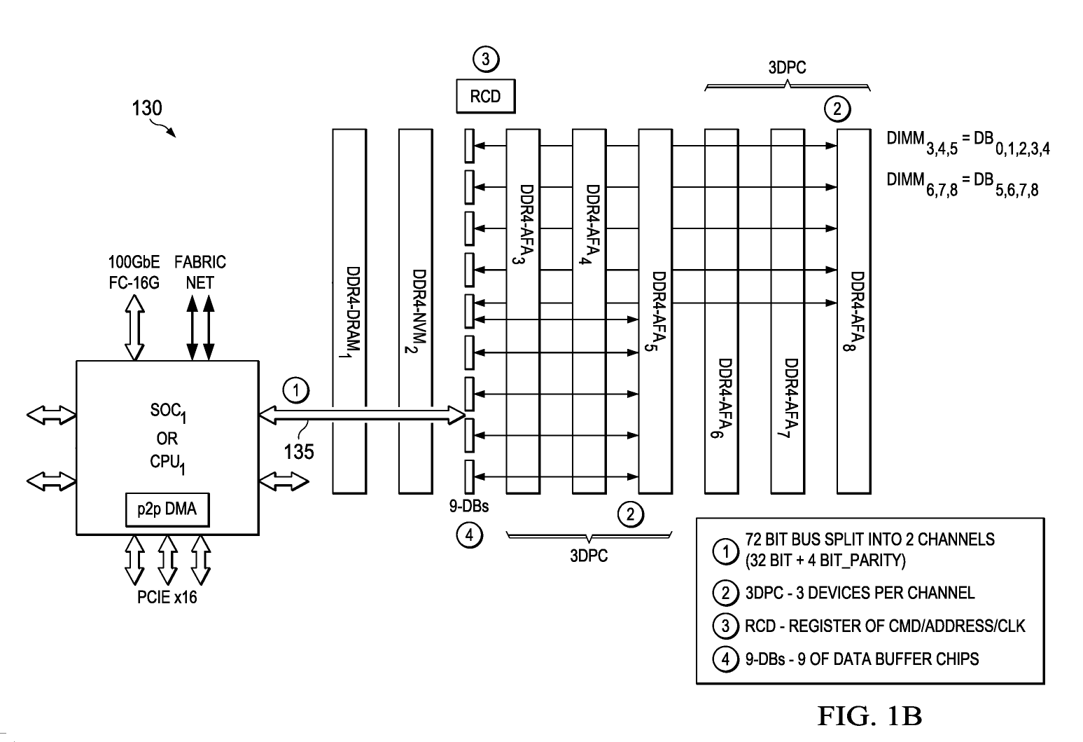

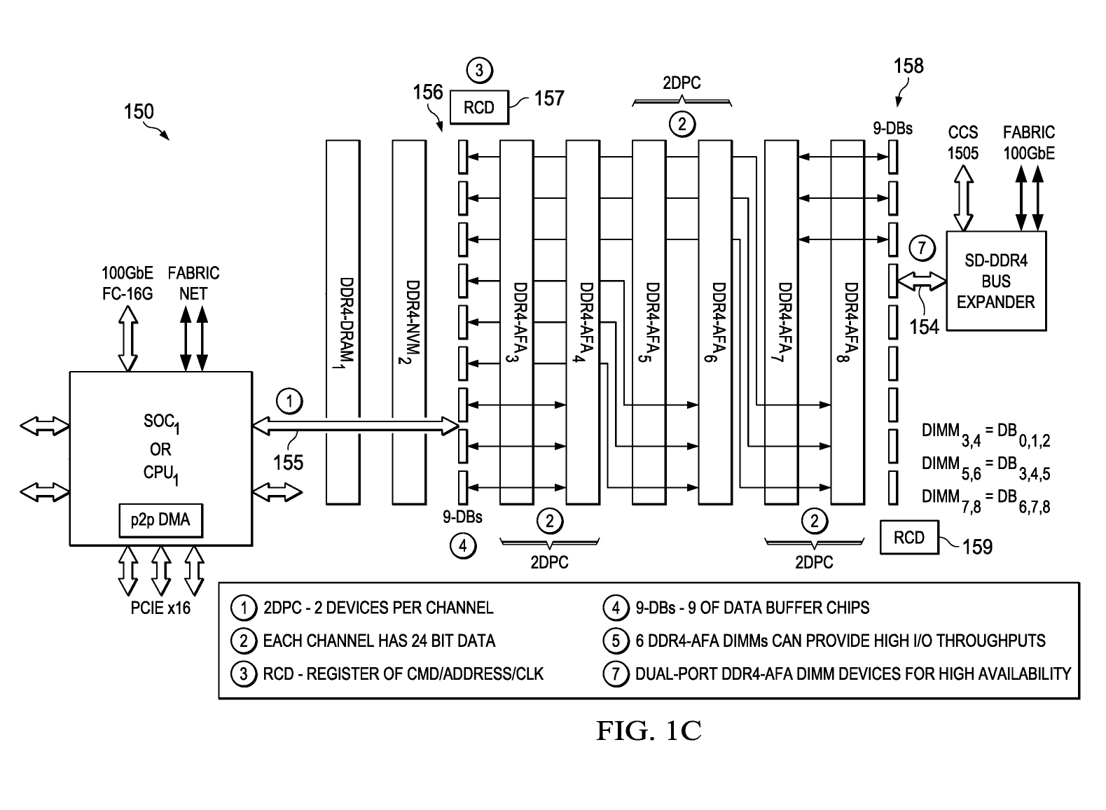

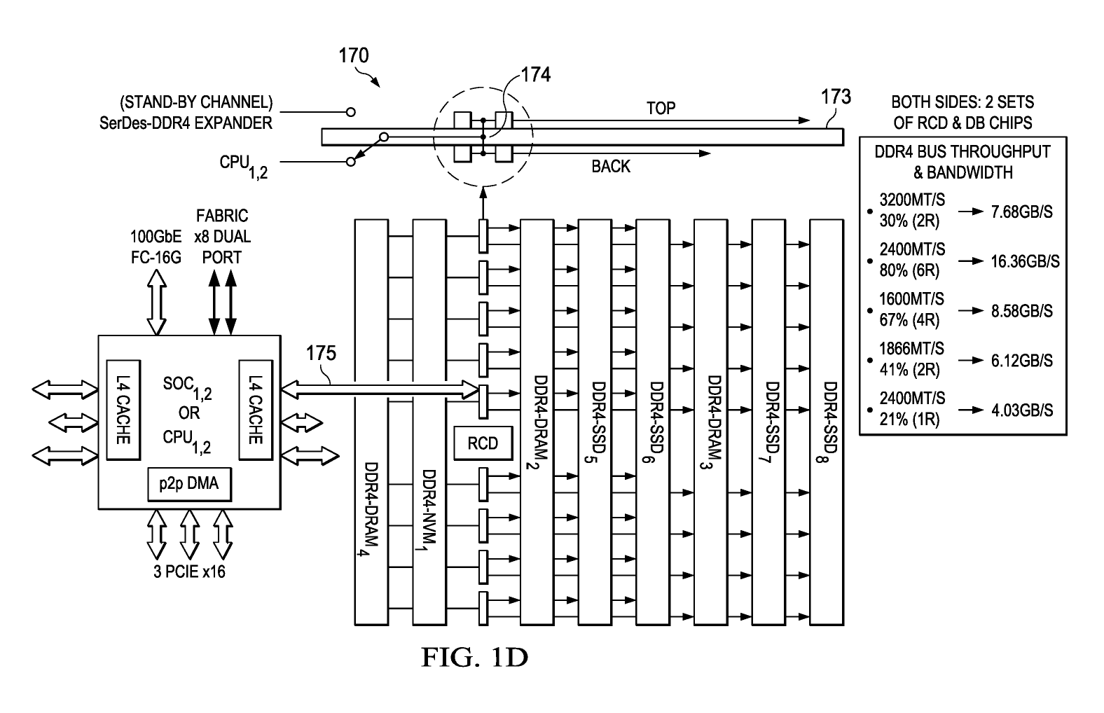

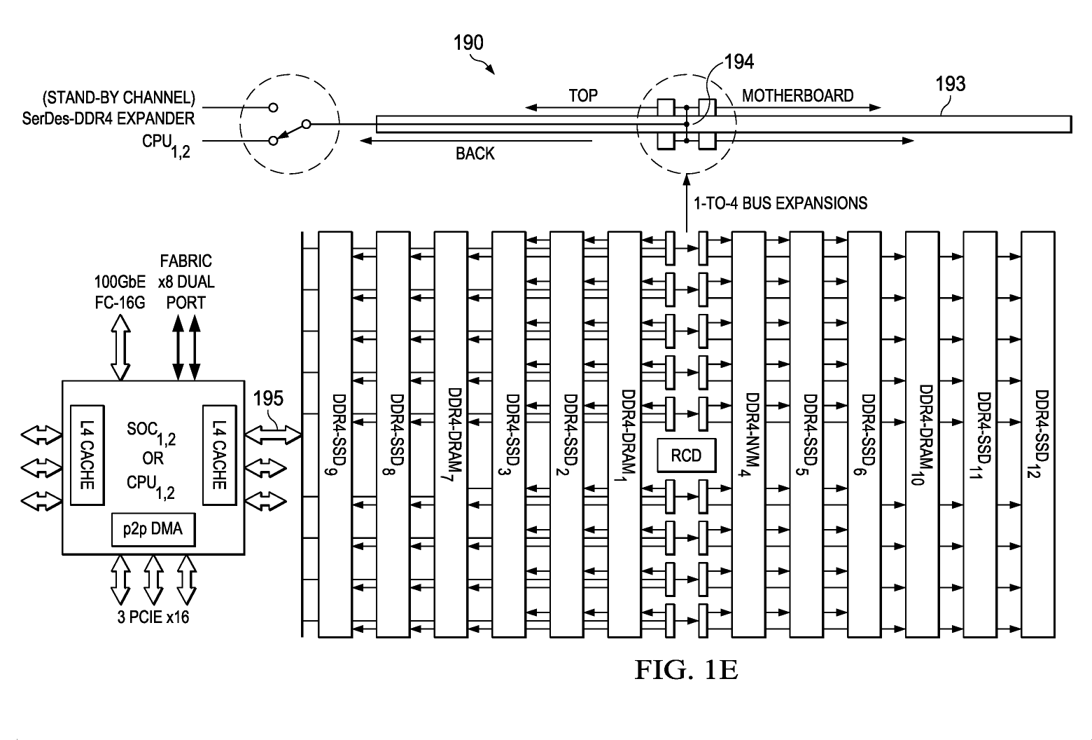

FIG. 1A shows an embodiment system 110 comprising a unified memory interface (UMI) DDR4 bus. The UMI buses 115 may host various memory media such as DRAMs, NVMs (e.g., MRAM, PCRAM, STT-MRAM, 3D-XP, ReRAM, etc.) and flash solid state storage devices (SSDs). In this embodiment, the system 110 comprises 4 UMI buses 115. For example, each 64 bit DDR4 UMI bus 115 can access 8 DDR4 SSDs. The DDR4 SSD (or DDR4 SSD device) may be a dual inline memory modules (DIMM) with two 8 bit DDR4 ports, one port connected to CPU₁ and another port connected to CPU₂ such that any one of two CPUs can access the data blocks stored in this DDR4 SSD device. Moreover, each DDR4 SSD may have one byte connected to CPU₁ and one byte to CPU₂ to form a dual-port DDR4 SSD. A dual port MRAM is placed between CPU₁ and CPU₂ for cache purposes.

FIG. 1B shows an embodiment system 130 comprising an unified memory interface (UMI) bus 135 for mixed memory media such as a DDR4-DRAM (device or DIMM), a DDR4-NVM (device or DIMM) and two groups of DDR4-All Flash Array (AFA SSD devices or AFA SSD DIMMs). The DDR4 AFA SSD DIMMs comprises two groups of dual-port DDR4-AFA SSD DIMMs. The UMI bus 135 (e.g., 72 bit bus) may be split into two channels (each channel having 32 bit data+4 bit parity) and each channel may support 3 DDR4 AFA SSD DIMMs. For example, the first channel supports the DDR4-AFA₃ SSD DIMM, the DDR4-AFA₄ SSD DIMM and the DDR4-AFA₅ SSD DIMM and the second channel supports the DDR4-AFA₆ SSD DIMM, the DDR4-AFA₇ SSD DIMM and the DDR4-AFA₈ SSD DIMM. The UMI bus 135 terminated by a data buffer (DB) and a control register (RCD) may relay drive the AFA SSD DIMMs. The data buffer (DB) may comprise 9 DB chips (a plurality of data buffers) and the control register (RCD) may comprise a single RCD or a plurality of RCDs. The RCD is a register for the Command/Address and Clock (CMD/Addr/CLK) fan-out to more devices. For example, The AFA_{3,4,5} SSD DIMMs are driven via the DBs_{0,2,3,4} and the AFA_{6,7,8} SSD DIMMs are driven via the DB_{5,6,7,8}.

FIG. 1C shows an embodiment system 150 comprising an unified memory interface (UMI) bus 155 for mixed memory media such as a DDR4-DRAM (device or DIMM), a DDR4-NVM (device or DIMM) and three groups of DDR4-AFA (SSD devices or DIMMs). The UMI bus 155 may be split into three channels (each channel having 24 bit data) and each channel may support 2 DDR4 AFA SSD DIMMs. For example, the first channel supports the DDR4-AFA₃ SSD DIMM and the DDR4-AFA₄ SSD DIMM, the second channel supports the DDR4-AFA₅ SSD DIMM and the DDR4-AFA₆ SSD DIMM, and the third channel supports the DDR4-AFA₇ SSD DIMM and the DDR4-AFA₈ SSD DIMM. The UMI bus 155 terminated by a data buffer (DB) and a control register (RCD) may relay drive the AFA SSD DIMMs. The data buffer may comprise 9 DB chips (a plurality of data buffers) and the RCD may comprise a single RCD or a plurality of RCDs. The RCD is the register for the CMD/Addr/CLK fan-out to more devices. For example, The AFA_{3,4} SSD DIMMs are driven via the DBs_{0,1,2}, the AFA_{5,6} SSD DIMMs are driven via the DBs_{3,4,5} and AFA_{7,8} SSD DIMMs are driven via the DB_{6,7,8}.

The AFA SSD DIMMs are connected to primary data buffers (DB) 156 driven by the CPU. A primary RCD 157 is the first register for the CMD/Addr/CLK control bus. In some embodiments two (or more) of the AFA SSD DIMMs may be dual port AFA SSD DIMMs. For example, the DDR-AFA₇ DIMM and DDR-AFA₈ DIMM are the dual port DIMMs. The dual port DIMMs may be connected to a secondary data buffers 158. The secondary data buffers 158 may also comprise 9 DB chips. A secondary RCD 159 is the second register for the CMD/Addr/CLK control bus. The secondary data buffers 158 and the control bus 154 may be connected to a serialize/de-serialize SD-DDR4 bus expander for chassis scaling-up or mirroring with a buddy server by either Cache Coherent linkage (CCS) or Fabric network. The SD-DDR4 bus expander may have the dual-port Cache Coherent linkages with DMA engines for more SoC/CPUs to share the data and to update the cache in the background (DRAMs and NVM/SSD devices).

FIG. 1D shows an embodiment system 170 comprising an UMI bus 175 for mixed memory media such as DDR4-DRAMs (devices or DIMMs), DDR4-NVMs (devices or DIMMs) and DDR4-SSDs (DDR4 AFA SSD devices or DIMMs). The UMI bus 175 may be 64+8 bit DDR4 bus. The UMI bus 175 may be structured into 1-to-3 bus expansions by two sets of data buffers (DBs) and control registers (RCD), e.g., fan-out driving circuits. A first set (DB/RCD) is located on a top side of a carrier 173 (e.g., printed circuit board (PCB)) and a second set (DB/RCD) is located on the bottom (back) side of the carrier 173. There is a static bus-switch 174 for the CPU_{1 or 2} to access the DDR4-DRAM DIMMs and DDR4-SSD DIMMs or the SD-DDR4 expander as a redundant data path to access these memories. The L4-cache may be a multi-GB DRAM modules embedded into the SoC/CPU.

FIG. 1E shows an embodiment system 190 comprising an UMI bus 195 for mixed memory media such as DDR4-DRAMs (devices or DIMMs), DDR4-NVMs (devise or DIMMs) and DDR4-SSDs (DDR4 AFA SSD devices or DIMMs). The UMI bus 195 may be 64+8 bit DDR4 bus. The UMI bus 195 may have 1-to-4 bus expansions by four sets of data buffers (DBs) and control registers (RCDs). Two sets may be located on the top side of a carrier 173 (e.g., PCB) and two sets may be located on the back side of the carrier 173. There is a static bus-switch 174 for the CPU_{1 or 2} to access the DDR4-DRAM DIMMs and DDR4-SSD DIMMs or the SD-DDR4 expander for a redundant data path to access these memories.

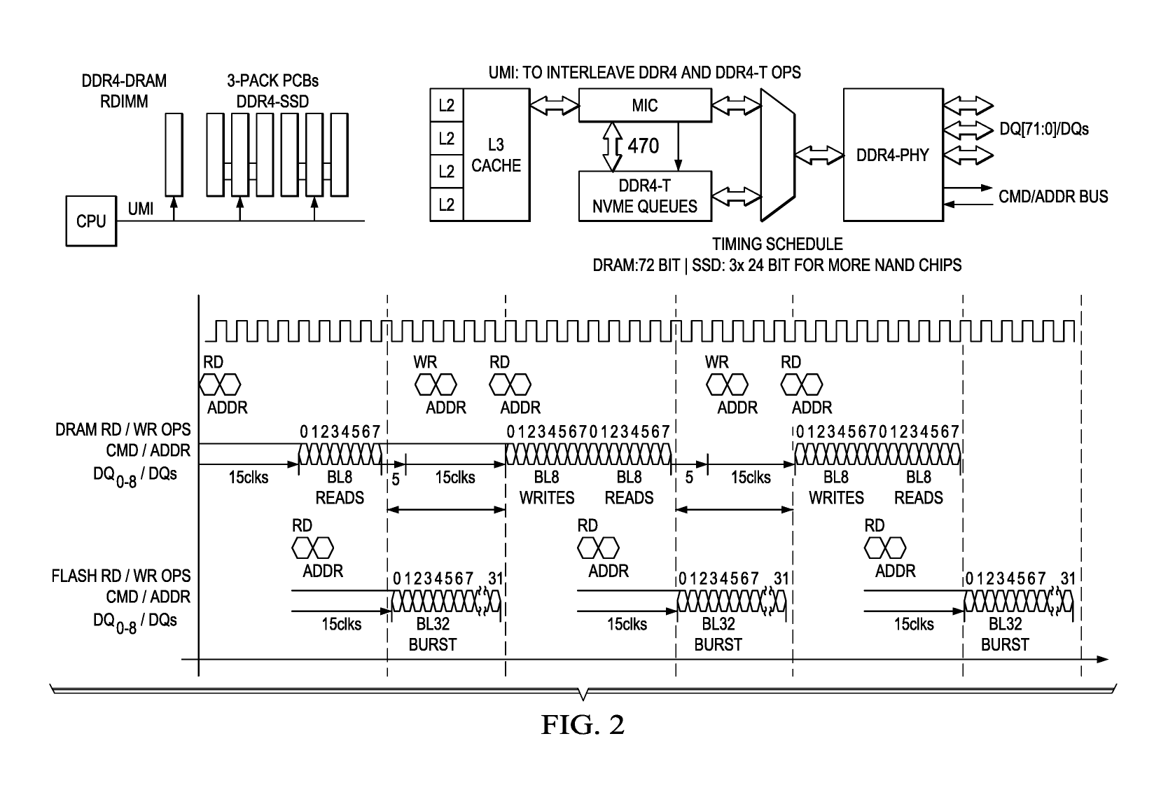

FIG. 2 shows a timing diagram for an united memory interface (UMI) bus. The CPU is connected via a united memory interface (UMI) bus to a DDR4-DRAM DIMM and NVM/SSD DIMMs. The timing diagram shows alternate or interleaved read/write operations for the DDR4-DRAM DIMM and block read/write operations for the NVM/SSD DIMMs devices. In alternative embodiments, the timing diagram may show sequential reads for the DDR4-DRAM DIMM. Moreover, instead, or additionally to the DDR4-SSD DIMM read/write traffic, NVM devices may also be using the bus in block read/write operations as the NVM memory capacity becomes larger than the single rank DRAM bus addressing ranges. Hence, a block access method may be applied.

The unified memory interface (UMI) bus may be configured so that the timing commands for the NVMs/SSDs block access operations are interleaved with the timing commands of the DRAM devices cache-line accesses so that the overall bus utilization of the UMI system is substantially improved. The two set of bus control commands/addresses queues and termination control mechanisms can share/drive the same high speed data DQ[71:0]/strobe DQs[17:0] DDR4 channel.

This timing diagram illustrates stealing DDR4 bus cycles by inserting NVM/SSD block accesses in DRAM bus waiting cycles according to an embodiment. In a conventional system two DDR4-DRAM DIMMs may use the UMI bus with sixty percent (60%) bus utilization. A DDR-SSD DIMM may have less than ten percent (10%) bus utilization. Three DDR4-SSD DIMMs (in some embodiments two, three or more DDR4-SSD DIMMs) may use the UMI bus simultaneously to insert the BL32 burst read/write operations into forty percent (40%) of DQ [71:0] bus idle cycles. The new BL32 mode can carry out 256 B (8×32B)˜4 KB flash block read, 16 KB burst write operations. The BL32 burst may be generated by the UMI controller to use 4 consecutive interleaving-bank reads/writes with the same column/row addresses for 256 B block data accesses. Two consecutive BL32 may form 512 B accesses. The UMI bus may reach 95% bus utilization, even when each DDR4-SSD DIMM has only 10% of DRAM throughput and its NAND chips are slower than the DRAM chips. For example, this high utilization may be reached by utilizing the 72 bit DRAM bus with the 8-channels DDR4 8 bit flash buses to support eight times of 8 bit DDR4-SSD devices.

The DDR4-DRAM chips generally have the best bus performance with shortest read/write latencies for random BC4 or BL8 accesses. The DDR4-NVM chips (e.g., MRAM chips) may have the same DDR4 speed with various read/write latencies. The DDR4-SSDs or NVMs (e.g., NAND or NVM chips) may have the same bus speed but with block read/write accesses such that one CMD/address may handle a longer burst of data and use the DRAM/NVM random access waiting time slot (e.g., BL32 for 256 B, burst read/write inserted in between BL8 read/write intervals). The BL32 may be generated by the UMI controller by 4 consecutive interleaving-bank read/writes with the same DRAM column/row addresses for 256 B burst access (e.g. BG[0,1,2,3]BK[0] or BG[0,1,2,3]BK[2]) or by two consecutive BL32 for 512 B burst access. Even the NVM/SSD controller internal memory size could be less than 512 MB (1 bank) of DRAM.

The timing diagram includes performing a first memory access of a DDR4-DRAM or a DDR4-NVM by issuing a read command or a write command or both. During the first memory access, a first command (e.g., a read command) may be issued to initiate a block memory access to a DDR4-SSD. After the first memory access is complete, the block memory access is performed. During the block memory access, a second command is issued to initiate a second memory access to the DDR4-DRAM or the DDR4-NVM (e.g., MRAM). After the block memory access is complete, the second memory access is performed. During the second memory access a second command (e.g., a read command) is issued to initiate a block memory access of the DDR4-SSD. The UMI may repeat this access pattern. An advantage of such an access pattern is that 95% bus utilization may be reached.

The timing diagram shows specific latencies and burst lengths. However, in some embodiments, the burst length of the DRAM devices or NVM devices may be different from BL8 and the burst lengths of the SSDs may be different from BL32.

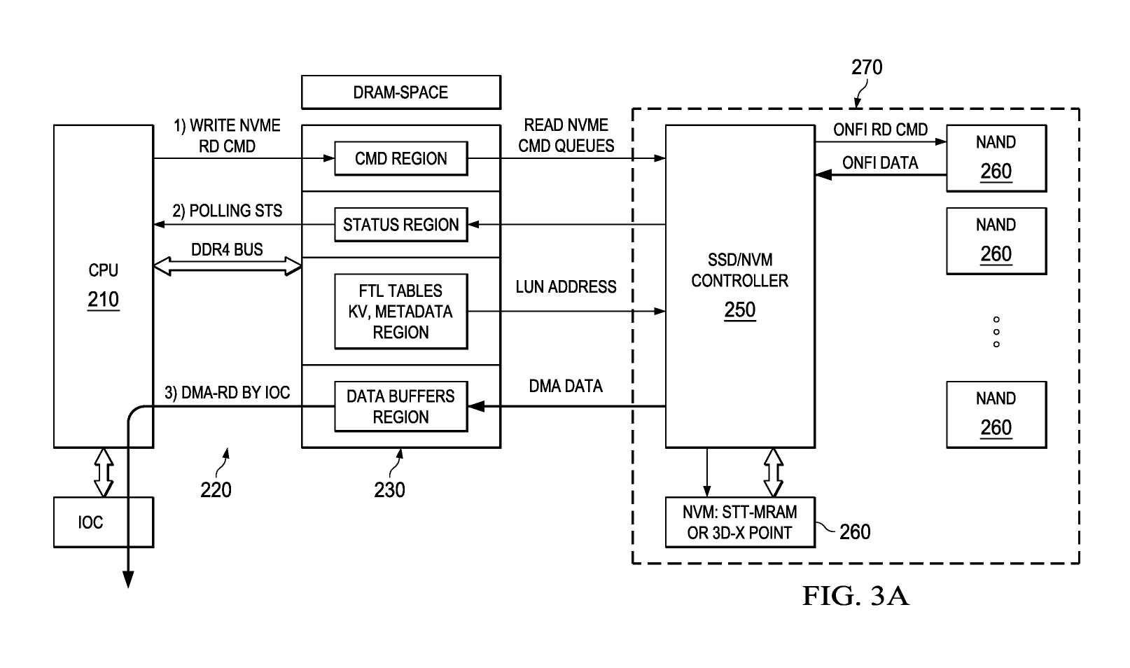

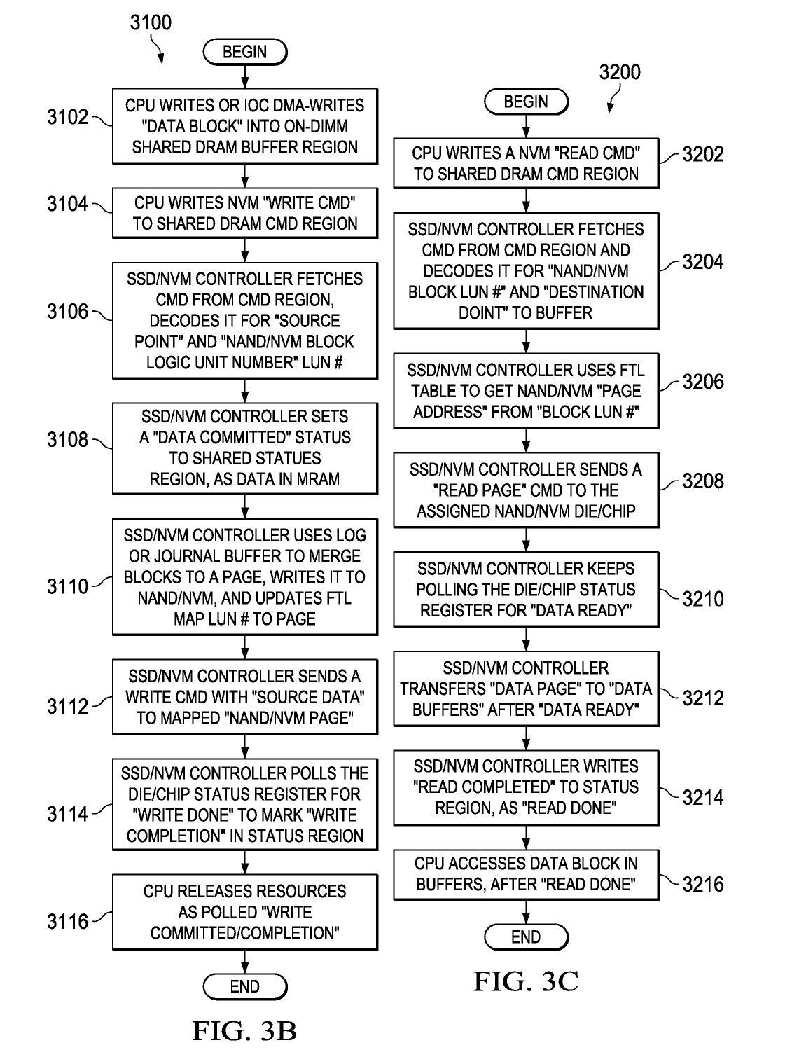

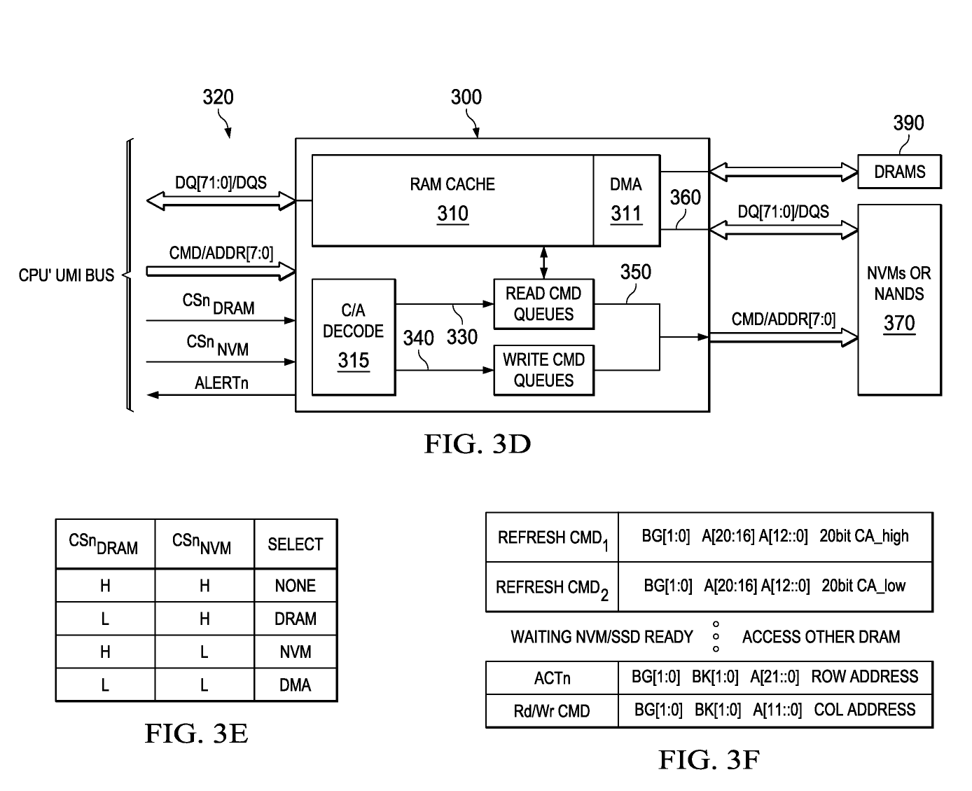

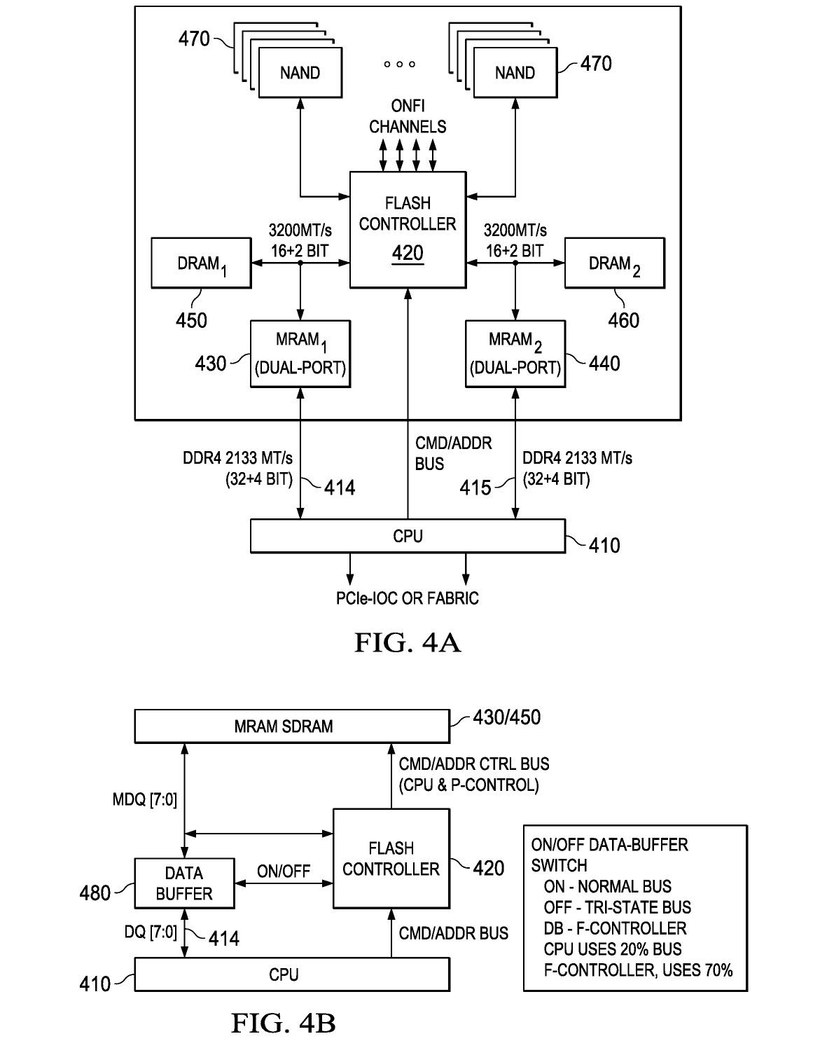

FIG. 3A shows an embodiment system comprising a processor 210, an UMI bus 220, a shared buffer 230, a NVM controller 250 and NAND and NVM devices 260. The processor such as a CPU 210 (comprising a UMI bus controller) controls through an UMI bus 220 a DDR4-NVM/SSD DIMM via a shared buffer (e.g., DRAM device, DRAM DIMM or DRAM chips) by a DDR4-T transport protocol. The shared buffer 230 may be the DDR4-DRAM DIMM in a UMI bus expansion segment that is directly managed by the CPU's virtual memory controller. The shared buffer 230 can also be accessed by the NVM/SSD controller(s) 250 of DDR4-NVM/SSD devices 260 (SSD devices or NVM devices). In some embodiments the DRAM device 230 may be located in the DDR4-NVM/SSD DIMM 270. In other embodiments, the NVM/SSD DIMM 270 may comprise a NVM/SSD controller 250 without a DRAM device 230. The DRAM device 230 may be a device or DIMM outside of the NVM/SSD DIMM 270. This NVM/SSD controller 250 may comprise internal or build-in RAM memories. The shared buffer 230 may be partitioned into “CMD,” “Status,” “Data-buffers,” and “FTL meta” regions. The DDR4-NVM/SSD DIMM 270 may comprise NVM devices 260 and an NVM controller 250 (and no SSD devices), SSD device 260 and an SSD controller 250 (and no NVM devise) or mixed NVM and SSD devices 260 and a NVM/SSD controller 250.

The processor 210 (e.g., CPU) may write NVM (non-volatile memory) commands and other control commands to the “CMD” region. The basic NVM/SSD read/write access CMD descriptors include the data addresses to point at the corresponding “Data-buffers” regions and the data block Logic Unit Number in the SSD or NVM devices. The NVM/SSD-controller 250 reads these CMD descriptors as the DDR4 CMD/Address informs the controller 250 when and where to read the incoming CMD descriptors from the DRAM chips or DIMMs 230 and then to process these CMDs. The controller 250 writes the corresponding operation status to the Status region after the CMD is executed to inform the processor 210 (e.g., CPU) with “CMD completed” or “Error codes” messages. The “CMD” and “Status” may be BL8 random read/write accesses. The processor 210 (e.g., CPU) may read/write DRAM “Data-buffers” in BL32 256 B or 512 B bursts to access a block of data in the NAND or NVM chips.

FIG. 3B is a flow diagram 3100 for writing data according to an embodiment. The process 3100 begins at block 3102 where the processor sometimes also referred to a host (e.g., CPU) writes or IOC DMA-writes a “data block” into a shared DRAM (such as an on-DIMM shared DRAM) data buffers region, for example, in 512 B to 4 KB (2-16 BL32 operations). Thereafter, at block 3104, the processor issues a NVM/SSD “write CMD” associated with this data block to the shared DRAM CMD region. At block 3106, the NVM/SSD controller reads the command with the descriptors as it senses the CMD/Address bus. The controller sends write commands with the data from the DRAM data buffer region to the assigned NVM/SSD page or pages. For example, the NVM/SSD fetches this CMD and decodes it for “source data point” and “NAND/NVM block Logic Unit Number” (LUN#). At block 3108 the NVM/SSD controller sets a “data committed” status to the Status region to inform the processor that the data were saved in the NVM such as the MRAM. At block 3110, the NVM/SSD controller uses log or journal buffer to merge small blocks into a 16 KB or 3×16 KB page/pages and writes it to a NAND/NVM chip, then updates the FLT table to map this LUN# to the NAND/NVM chip and page and at block 3112, the NVM/SSD controller sends a write CMD with “source data” to the mapped “NAND/NVM page.” At block 3114, the NVM/SSD controller polls or periodically polls the related NAND/NVM chip status register for “write done” in order to post “write completion” or “error” to the related shared DRAM Status region when the task is done. At block 3116, the processor may poll (drive) “write committed or completed” status to release processor resources for more NVM block write operations.

FIG. 3C is a flow diagram 3200 for reading data according to an embodiment. The method 3200 begins at block 3202 where the processor (e.g., CPU) issues a NVM “read CMD” to the CMD region. At block 3204, the NVM/SSD controller fetches the read CMD from CMD region and decodes it for “NAND/NVM block LUN#” and “destination point” to buffers and at block 3206, the NVM/SSD controller uses a flash transition layer (FTL) table to get NAND/NVM “page address” from the LUN#. At block 3208, the controller sends “read page” CMD to the assigned NAND/NVM chip and at block 3210, the NVM/SSD controller keeps polling the related chip status register for “data ready” signal. Then, at block 3212, the NVM/SSD controller transfers the data block from the mapped NAND page to “destination buffer” at the pointed “Data-buffers” region after it polled the “data ready” status. At block 3214, the NVM/SSD controller writes “read completed” to Status region to inform the processor of “read done” and data ready. At block 3216, the processor can access this data block or sets-off the IOC to directly DMA-read the data block from the proper “Data-buffers” region.

In various embodiments the NAND/NVM chip can be a NAND flash chip, a NVM chip or a combination thereof. In further embodiments the NVM could be a random accessed memory, a block accessed memory or both, a random accessed memory and a block accessed memory. The STT-MRAM may be random accessed non-volatile memory with close to DRAM access latencies and the 3D-X Point PCRAM may be block accessed non-volatile memory.

Both the processor (e.g., CPU) and the NVM/SSD controller may control and manipulate the flash transition layer (FTL) and metadata for high performance DDR4-SSD or NVM access processes.

FIG. 3D shows a functional block diagram of a NVM/SSD controller 300. The controller 300 may be connected to a CPU with an UMI bus 320 and connected to the RAMs (such as DRAMs) 390 and NVM/SSDs 370. The NVM/SSD 300 controller comprises a RAM cache 310 with a direct memory access (DMA) unit 311, several registers and a decoder 315 for example.

The controller 300 obtains through the UMI CMD/Address bus 320 the host CPU's read or write NVM/SSD commands. The controller 300 decodes the 40 bits or 60 bit control-words for read CMD queues 330 or for write CMD queues 340. The read/write CMD queues may be load balanced to be sent to the NVMs/SSDs 370 from the controller 300 by a dedicate CMD/Address bus or by an ONFI bus with lower latencies. The NVM/SSD read/write CMDs could also be fetched from the internal RAM CMD region as described with respect to FIGS. 3B and 3C. The commands may include 16+4 clock cycles DDR4 bus delay and 16 clock cycles internal RAM delay.

FIG. 3E shows a select table. FIG. 3E shows the truth table to decode CSn_{DRAM} and CSn_{NVM} signals. For example, HH may stand for CPU not select devices, LH may stand for selecting DRAM, and HL may stand for using the NVM/SSD controller. LL may inform the NVM/SSD controller that the CPU is using the UMI for other UMI devices. The NVM/SSD controller could use the DRAM 390 or the internal RAM 310 without getting into conflict with the CPU access. For example, the NVM/SSD controller could use the DMA unit 311 to transfer data between DRAM chips 390 and NVM/SSD chips 370.

FIG. 3F shows a refreshing command table. The table of FIG. 3F shows the CPU using two DRAM refreshing commands to pass a 40 bit read/write command or three refreshing commands to pass a 60 bit read/write command to the NVM/SSD controller. Afterwards, the CPU can access other DRAM-devices. Afterwards, CPU commands read the DRAM 390 or internal RAM 310 pointed by the 40 bit or 60 bit read descriptor by four BL8 reads of 256B data, for example. The ALERTn signal of the UMI CMD/Address bus 320 would be set Low to interrupt the CPU within the 16 clock cycles latency CL=16, if the data were not ready yet or the ALERTn signal may be set Low to inform the CPU that the data were out of order.

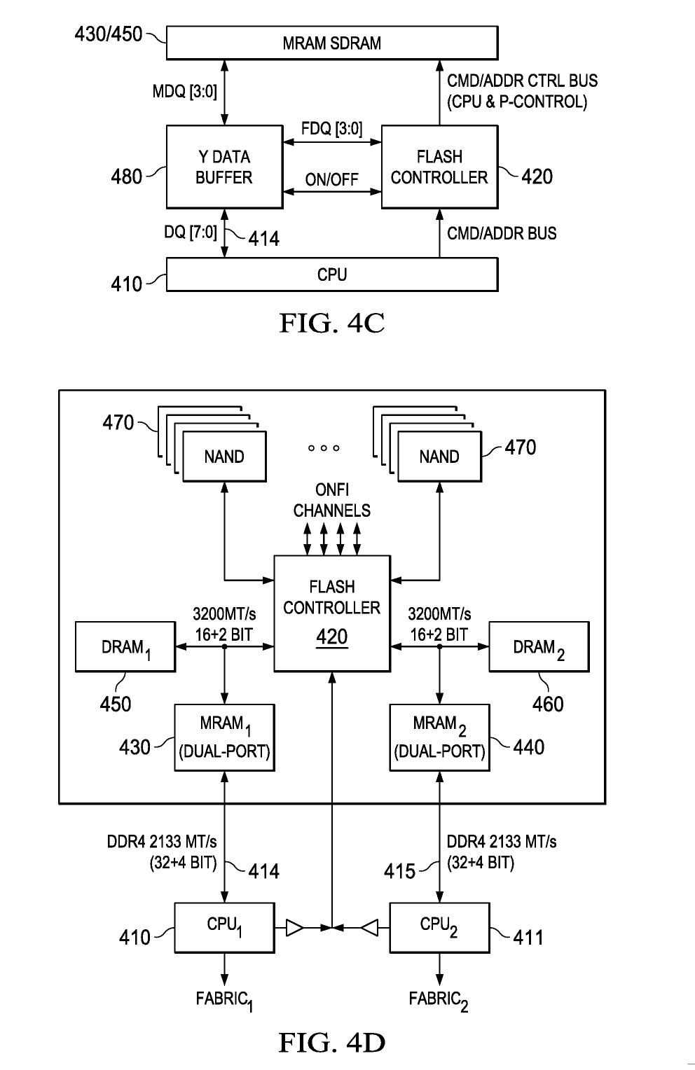

In FIGS. 4A-4D illustrate a system comprising a CPU and a dual port DDR4 SSD DIMM with dual port NVM/DRAM(s). The DDR4-SSD DIMM is interfaced by dual-port NVM devices (such as fast STT-MRAM chips) or RAM devices (such as DRAM chips) such that one port is accessed by a processor (e.g., CPU) and the other port is accessed by a flash controller. The flash controller and the CPU may exchange CMDs/Data-blocks/Statues updates via transport protocols through the DDR4 bus(es). The MRAM device may be featured as a non-volatile write cache (or catch buffer) to allow the CPU committing a SSD write operation immediately after the data block is written into the MRAM device and before the block is written into the assigned flash NAND page. In an example, the CPU may write incoming data into the MRAM device and then respond within 1 μs for later writing to the data to flash pages which is fast compared to the conventional 1 ms range of flash NAND write completion latency.

FIG. 4A shows a functional block diagram for a single CPU to access a DDR4-SSD DIMM with two dual port NVM devices (e.g., MRAM chips) and a flash controller. FIG. 4B and 4C show a block diagram with a dual-port data buffer and FIG. 4D shows a block diagram for two CPUs to access a DDR4-SSD DIMM via right/left side dual port NVM devices (e.g., MRAM chips). The DDR4 bus is split into two paths. For example, a DDR4 72 bit bus is split into two paths, one for the CPU₁ and another for the CPU₂. This bus may provide a higher data reliability and availability compared to a single path approach.

FIG. 4A illustrates a DDR4-SSD DIMM for standard data servers. The CPU 410 is communicatively connected via the UMI bus data channel to the right/left side dual-port NVM devices (e.g., (fast) MRAM chips) 430 and 440. The dual-port MRAM chips 430 and 440 are communicatively connected to the flash controller 420 and the flash controller 420 is communicatively connected to a set of Flash NAND devices 470 (e.g., Flash NAND chips). The RAM devices (e.g., DRAM chips) 450, 460 may be communicatively connected to the NVM devices 430, 440 and the flash controller 420. The NVM devices 430, 440, the RAM devices 450, 460, the flash controller 420 and the NAND devices 470 may form the DDR4-SSD DIMM. The DDR4 data bus may be split into two DDR4 32 bit+4 bit bus 414, 415 at 2133 MT/s speed. The buses 434, 435 may each be a 16 bit+2 bit bus at 3200 MT/s speed at the flash controller port.

The CPU 410 may directly control the flash controller 420 via a command/address bus by two or three DRAM refreshing CMDs. The flash controller 420 controls the right/left NVM devices 430, 440 and the right/left RAM devices 450, 460. The flash controller 420 may capture the CPU's active CMD/Address signals to write to the NVM devices 430, 440 and RAM devices 450, 460 and passes these signals to access the NVM or RAM devices 430-460. The flash controller 420 can issue its own CMD/Address signals to access the and RAM devices 430-460 since the CPU CMD/Address signals may drive other DDR4-DIMMs as described in previous flow-charts FIG. 3B and 3C.

The embodiment of FIG. 4B illustrates a data buffer 480 and a NVM/RAM memory (device or chip) 430 to form a dual-port arrangement 430/480. The NVM device may be a (fast) MRAM device and the RAM device may be a DRAM device. The NVM and the DRAM devices may be separate and individual chips or embedded in the flash controller 420. The NVM/RAM 430, the flash controller 420 and the data buffer 480 are connected via tri state bus. The data buffer 480 and the flash controller 420 may ping-pong switch the data path between the CPU 410 (data buffer 480 ON) and the flash controller 420 (data buffer 480 OFF) to share the NVM/RAM memory 430. The data buffer 480 may have duplex FIFOs. The data buffer 480 interconnects the CPU and the NVM/RAM 430 when it is set to ON and the data buffer 480 interconnects the flash controller 420 to the NVM/RAM 430 when it set to OFF.

The data buffer 480 (e.g., 8 bit buffer) is placed between the CPU 410 and the NVM/RAM device 430/450 (e.g., MRAM chip, DRAM chip or both). The data buffer 480 is communicatively connected to the NVM/RAM device 430/450 for CPU 410 to access the NVM/RAM device. At CPU idle time (CPU 410 may operate other DIMMs and not this DIMM) the flash controller 420 may access the NVM/RAM device 430/450. The flash controller 420 may provide the CMD/Address (either own or from the CPU) to the NVM/RAM device 430/450, and switch on/off the data buffer as it wants to access the NVM/RAM device 430/450. The CPU bus 414 may be a 72 bit bus with 9 sets of 8 bit dual-port data buffers (one disclosed here and 8 additional dual-port buffers of other DIMMs (not shown). The CPU 410 may use 20% of the bus 414 by 1-rank access to the DDR4 device and the flash controller 420 may use 70% bus times of the shared NVM/RAM device 430/450 by consecutive inter-bank multi-burst accesses.

The embodiment of FIG. 4C is similar to the embodiment of FIG. 4B. FIG. 4C illustrates a 3-way data buffer (or Y data buffer) 480 and a NVM/RAM device 430 to form the dual-port arrangement 430/480. This Y-data buffer 480 is a dual-port device to allow two hosts (CPU and flash controller) to share the NVM/RAM device 430. The Y data buffer 480 switches for the CPU 410 or the flash controller 420.

FIG. 4C shows the 3-way data buffer (Y-data buffer) 480 placed between the CPU 410 and the NVM/RAM device 430/450 (e.g., MRAM chip or DRAM chip or both) and the flash controller 420. The Y-data buffer 480 may have 3 ports, one 8 bit port for CPU 410, one 4 bit port for flash controller 420, and one 4 bit port for the shared NVM/RAM device 430/450. The buffer 480 may comprise the same small package as conventional 8 bit DDR4 data buffer. The flash controller 420 provides CMD/Address to the NVM/RAM device 430/450 and switches the data paths of the Y-data buffer 480 for either the CPU or the flash controller to access the NVM/RAM device 430/450. This Y-data buffer 480 may comprise an unsynchronized FIFOs in each paths to adapt different port widths (e.g., DQ[7:0] port to MDQ[3:0] port to FDQ[3:0] port) and may comprise different speeds to reduce the number of MRAM or DRAM chips. Such a buffer may allow a larger number of flash NAND chips for higher total storage capacity on the DDR4-SSD DIMM. As pointed out before, all devices may be located on the same DIMM.

The embodiment of FIG. 4D is similar to that of FIG. 4A. FIG. 4D illustrates the same DDR4-SSD DIMM as in FIG. 4A but is configured as dual-port DDR4-SSD DIMM. The dual port DDR4-SSD DIMM may include a shared CMD/Address control bus and a split 72 bit data bus (e.g., two 36 bit data ports) for CPU₁ and CPU₂ accesses with a different flash controller firmware.

FIG. 4D shows an arrangement with two CPUs, a first CPU (CPU₁) 410 and a second CPU (CPU₂) 411 to access the dual-port DDR4-SSD DIMM. The CPUs 410 and 411 provide interleaving controls to the Flash controller 420 via a shared command/address bus from CPUs 410 and 411. The Flash controller 420 may pass the active CMD/Address signals to control the right/left side NVMs (MRAMs) or RAMs 430-460 (DRAMs). The flash controller 420 may issue its own CMD/Address signals to access NVMs or RAMs 430-460 as the CPUs 410, 411 are accessing other DDR4-DIMMs. The flash controller 420 may also access the NVMs 430 and 440, and the volatile memory devices 450 and 460, respectively, for more buffer space and FTL tables and metadata. The buses 414 and 415 may each be a data bus. Each bus may be a DDR4 32 bit+4 bit bus with of 2133 MT/s. The buses 434 and 435 may be a 16 bit+2 bit bus with of 3200 MT/s.

The two CPUs 410, 411 may access (e.g., read/write) the two dual-port NVM chips (e.g., MRAM chips) and the Flash-controller may access (e.g., read/write) the RAMs' CMD/STATUS/data-buffers space (at RAMs 450, 460) for getting two independent CPU controls and read/write data blocks. The CPUs 410, 411 may expand VM space to the DDR4-SSD (NAND flash block memory space). The dual-port NVM/DRAMs may be in CPU VM space and mapping. The management of the VM space of the DDR4-SSD (e.g., Flash FTL tables) may move to the CPUs 410, 411. The DDR4-SSD flash controller (e.g., device drive) may support both pooling and interrupt ops.

Embodiments provide nonvolatile storage capability at the UMI bus 414 and 415 for low read/write latency. Embodiments further provide a dual-port UMI bus for two CPUs 410 and 411 to directly access DDR4-SSD. Embodiments may provide expansion of the CPUs' VM memory space to DDR4-SSD on-board DRAM space. The VM to physical buffer number(PBN) and LUN to flash transition layer (FTL) tables can be managed by CPUs 410 and 411. The flash controller 420 can support both pooling and interrupt messaging modes. The dual-port DRAMs may also provide bus rate and width adaptations for delayed accesses. Embodiments further provide a bootable DDR4-SSD, BIOS and BMC management system.

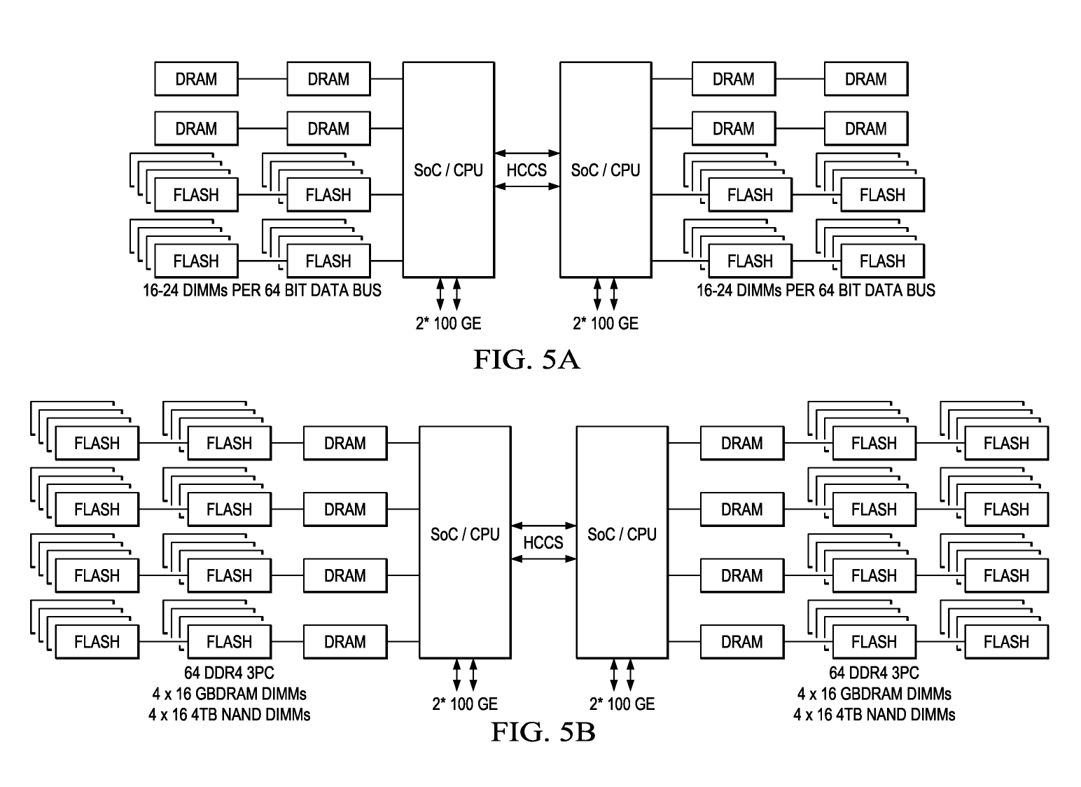

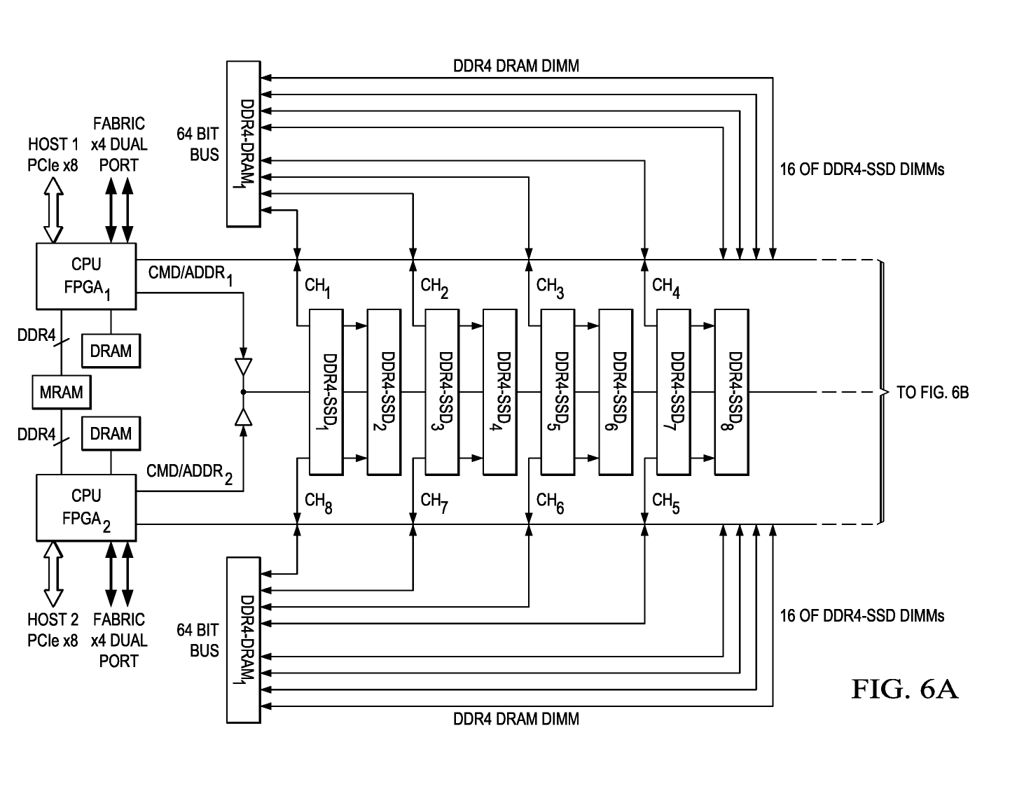

FIGS. 5A and 5B show a system comprising two CPUs with a 64 UMI bit bus with eight channels of 8 bits (8 bit mode) in order to host more DDR4-SSD DIMMs. For example, there are 24=8 ch*3 dev DDR4-SSD DIMMs per 64 bit buses.

FIG. 5A illustrates a CPU's 64 bit DDR4 bus. The UMI bus split into 8-channels of 8 bit DDR4-ONFI (open NAND flash interface) for 8 DDR4-DRAM and 32 DDR4-SSD DIMMs. FIG. 5A includes a SoC platform for primary storage. Benefits of using a SoC platform include providing higher storage capacity, providing build-in higher network I/O BW (utilization), and providing CPUs virtual memory space to allow the IOCs to directly DMA write/read the DRAM buffers in DDR4-SSDs, and the possibility to mix DDR4-DRAM devices, DDR4-NVM devices, and DDR4-SSD devices under the UMI buses.

FIG. 5B illustrates a unified memory interface (UMI) bus for SoCs or CPUs to access the DDR4-DRAM and DDR4-SSD according to an embodiment. The CPU's 64 bit UMI bus may mix the DDR4-DRAM random read/write accesses with the splitted 8-channels of the 8 bit DDR-ONFI for 128 DDR4-SSD DIMMs as single port DDR4-SSD devices.

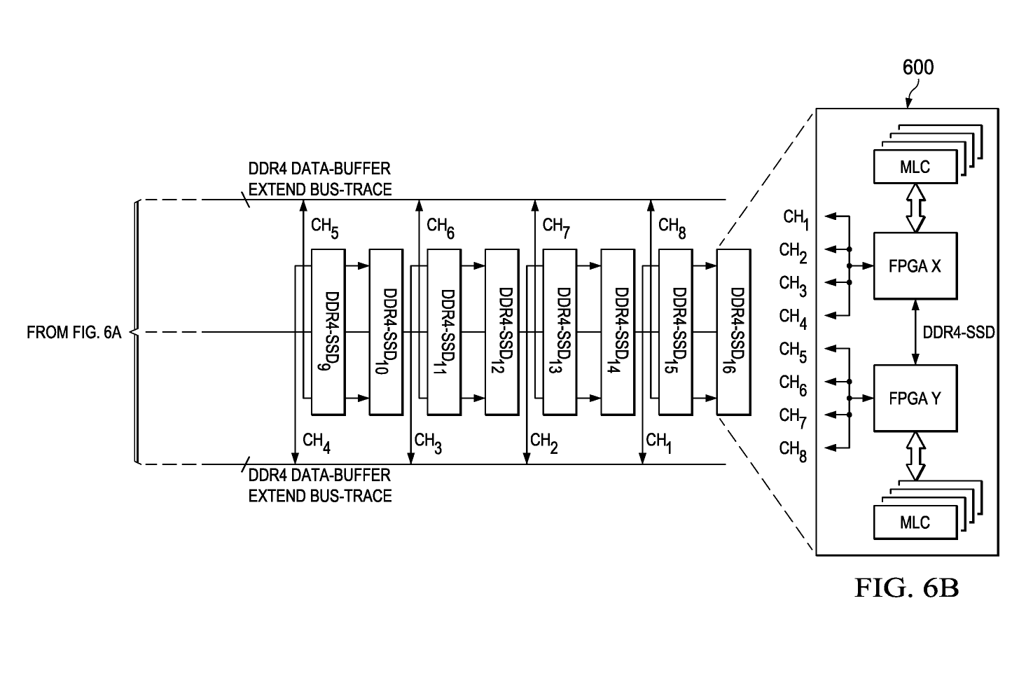

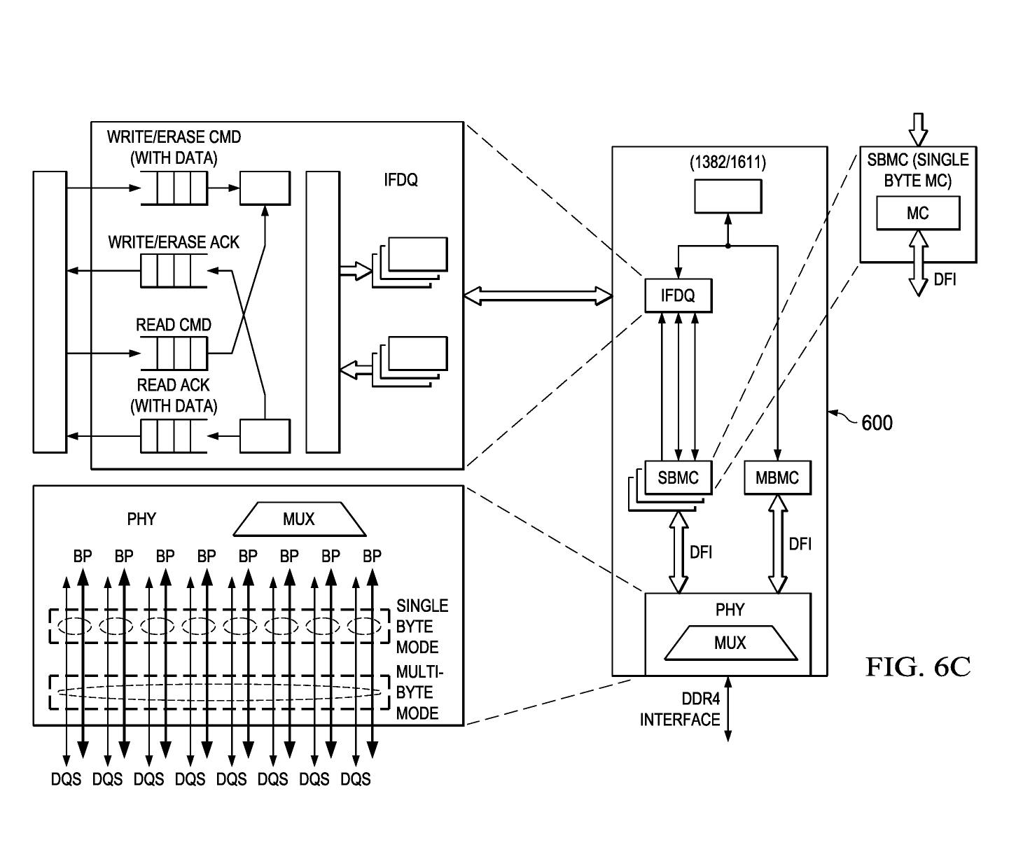

FIGS. 6A and 6B illustrate a system comprising a 64 bit DDR4 data bus connected to DDR4-DRAM (DIMMs) devices (top/bottom DDR4-DRAM_{1,2}) and 16 dual-port DDR4-SSD (DIMMs) devices according to an embodiment. Each 8 bit channel drives two SSD devices. Accordingly, a second access path for each SSD device is so that remote clients can access the SSD device. The second access path is added in order to enhance the storage availability and to eliminate the single failure probability. FIG. 6B shows the UMI controller 600 located inside a SoC or CPU. The controller 600 includes a 8 bit IFDQ interface DQ[7:0] that has the control CMD queues of the output (write to NVM/SSD) and ACK status of completion queues of the input (read from NVM/SSD status region). The controller 600 may further comprise a DDR4 PHY multiplex 8 of 8 bit DDR4-SSD sub-channels in order to access more SSD devices.

FIG. 6C illustrates the CPU's 64 bit UMI bus controller 600 having a MUX ping-ponging between DRAM-mode/protocol and NVM/Flash-mode/DDR4-T protocol for interleaving cache-line access and block access in the shared physical DDR4 bus. In an embodiment, the 8-channel DDR4-SSD (DDR4 data channels) expands CMD/addr into eight groups to control 8-channels. The DDR4-8 bit SSD DIMM can be mixed with an DDR4-DRAM DIMM, either using 40% of DRAM idle cycles or sharing 60% bus slots. The DDR4 8 bit SSD DIMM can be mapped into CPU VM space to support IOC DMA-reads/writes DDR4-SSD on DIMM DRAMs.

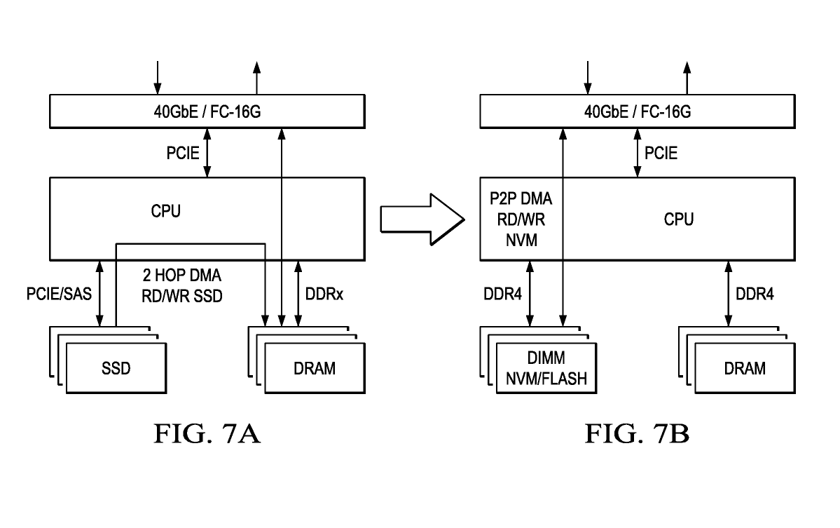

FIGS. 7A and 7B show a system comprising DDR4-DRAM buffers for PCIe-NVM/SSD devices and 40 GbE/FC-16G controllers (Input/Output Controllers (IOCs)). In FIG. 7A the DRAM buffers are host memories to support 2 hop DMA/rDMA read/write data traffics between the IOC(s) (40 GbE or FC-16×4) and the NVM/SSD storage devices. The PCIe controller may directly DMA read/write to the DRAM buffers for relaying the data from/to the IOCs to the SSD.NVM devices. The data on the SSD devices may be accessed by the IOCs using or applying IRQ (interrupt request) processes twice in 2 hop DMA operations. Using peer-to-peer DMA transfers between NVM/SSD storage devices and the IOC(s) can eliminate the 2 hop data traffics over the host DRAM buffers with 2 times CPU IRQ processes.

In some embodiments the SSD primary storages I/O data traffics may be 20% writes and 80% reads, for example. The PCIe-SSD/SAS-SSD read/write operations may have to use the CPU host memory bus twice to buffer I/O data so that CPU processor capacity may be limited by processing the host memory bus throughputs. Memory Channel Storage (MCS) SSD read/write operations may use the CPU bus three times to cache the SSD data blocks into other DDR4-DRAM devices. MCS may be applied for computing servers because applications already use the CPU bus heavily for other than storage operations. FIG. 7A shows that the SSD at the PCIe port may have to use CPU host memory to buffer the I/O data and then that the IOC device read/writes the buffered data to DMA (I/O data using host memory bus twice). In contrast, FIG. 7B shows the NVM/SSD DIMMs plugged into the CPU host UMI bus. The UMI bus may be directly DMA accessed by the IOC devices with only accessing the bus once. The other DDR4-DRAMs may only store headers and metadata as 1:1000 of data to header/metadata ratios.

Moreover, in some embodiment, the DDR4-NVM/Flash SSDs (with the dual port DRAM buffer chip or chips) do not compete with CPU memory buses by interleaving DRAM random accesses and NVM/SSD block accesses or stealing DRAM idle cycles for NVM/SSD block data transfers. The DDR4-NVM/SSD DIMMs may support the I/O controller DMA-read data block directly from an on-DIMM DRAM buffer (e.g., as 0-copy DMA in multiple 256 B transfers). A write data block could be buffered at the I/O controller or SCM (storage configuration manager) blade for data de-duplication. The CPU bus may avoid multiple copies of data. The CPU may only handle 1× time IRQ process per I/O transaction and the DDR4 bus may only have an one time data traffic, in DRAM-less NVM/SSD DIMM(s).

In various embodiments the disclosed system and the operation of the system may be applied to technologies beyond DDR4 such as GDDR5, High Bandwidth Memory (HBM) or Hybrid Memory Cube (HMC).

In embodiments the DDR4-SSD DIMMs may be referred to as DDR4-SSD devices, DDR4-NVM DIMMs may be referred herein as DDR4-NVM devices and DDR4-DRAM DIMMs may be referred to as DDR4-DRAM devices.

In some embodiment a DDR4-DRAM DIMM may have three 3 interfaces (a) DDR4 DQ[71:0]/DQS[17:0] data channel for high-speed data read/write access operations, (b) Commands/Address control channel for CPU to control the SDRAM chips on the DIMM and (c) i2c serial bus for temperature sensor and EEPROM as out-band managements.

In certain embodiments, the CPU (motherboard or main-board) or the system on chip (SoC) may comprise a small Board Management CPU (BMC) that may scan and manage all the i2c controller hardware components for their device types, functional parameters, temperatures, voltage levels, fan speeds, etc., as out-band remote management path to networked management servers.

In some embodiment, at the system power-up, the BMC may scan all on-board components or SoC components to make sure that the motherboard/main-board or the SoC is in proper working condition to boot-load the Operation System. At the power-up moment, BMC uses the i2c bus to read the EEPROM info on each DDR4-DRAM, DDR4-NVM (e.g., MRAM), DDR4-3D-XPoint, DDR4-Flash devices to identify the parameter of each DDR4 memory bus slot. The bus slot may include the following parameters: the type of memory device, the size of the memory device and access latencies of the memory device. BMC may then report these parameters to the CPU. Accordingly, the CPU may know how to control the mixed DDR4 memory devices on the motherboard with properly fitted access protocols and latencies. The DDR4-SSD block devices then load the proper device driver to support the SSD controls and direct DMA/rDMA read/write operations.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. A system comprising:
a unified memory interface (UMI) bus;
a CPU coupled to the UMI bus;
a RAM/NVM device coupled to the UMI bus; and
NVM/SSD devices coupled to the UMI bus, wherein the UMI bus is configured to use RAM/NVM device random access waiting cycles to block access the NVM/SSD devices.

2. The system according to claim 1, wherein a UMI bus speed is the same for the NVM/SSD devices and the RAM/NVM device.

3. The system according to claim 1, wherein the block access is a BL32 256 B burst, and wherein the random access is a BC4 or BL8 cache-line of 32 bytes or 64 bytes.

4. The system according to claim 3, wherein the BL32 burst operations comprise four DRAM consecutive bank-interleaving accesses with the same column/row address to the NVM/SSD devices.

5. The system according to claim 1, wherein the UMI bus is a 72 bit bus.

6. The system according to claim 1, wherein the UMI bus is split into two 36 bit busses to support a first dual-port RAM/NVM device and a second dual port RAM/NVM device.

7. The system according to claim 1, wherein the NVM/SSD devices are arranged in a NVM/SSD DIMM, wherein the NVM/SSD DIMM comprises a NVM/SSD controller, and wherein the NVM/SSD controller is a dual port controller.

8. The system according to claim 1, wherein the NVM/SSD devices are arranged in a NVM/SSD DIMM, wherein the NVM/SSD DIMM comprises the RAM/NVM device, wherein the RAM/NVM device is a shared DRAM buffer, wherein the shared DRAM buffer is accessible by the CPU and a NVM/SSD controller of the NVM/SSD DIMM.

9. The system according to claim 8, wherein the shared DRAM buffer is partitioned into a CMD region, a status region, a data buffer region and a metadata region.

10. The system according to claim 9, wherein the shared DRAM buffer is an internal cache or RAM memory built in the NVM/SSD controller.

11. The system according to claim 10, wherein the CMD region and the status region are configured to be random DRAM accessed, and wherein the buffer region is configured to be block data accessed by interleaving bank accesses with the same column/row addresses.

12. The system according to claim 1, wherein the UMI bus is a DDR-4 UMI bus, wherein a RAM/NVM device is a DDR4-DRAM/NVM device, and wherein SSD-NVM devices are DDR4-NVM/SSD devices.

13. The system according to claim 1, wherein the UMI bus is configured to operate with a utilization rate of equal or higher than 85% by stealing DRAM bus waiting cycles to insert NVM/SSD block read/write data accesses into gaps of DRAM random read/write operations.

14. A method comprising:
performing a first memory write to a data buffer region of a memory buffer;
during the first memory write, receiving a first write command with CMD descriptors to initiate a block memory write to a NAND/NVM device at a CMD region of the memory buffer;
performing the block memory write to transfer data from the data buffer region to a NAND/NVM page according to the first write command;
polling for a NAND/NVM page write completion status from a NAND/NVM status register;
setting the write completion status or an error message at a status region of the memory buffer to inform a host about a NAND/NVM status; and
during the block memory write, performing a second memory write to the data buffer region.

15. The method according to claim 14, wherein the memory buffer is an internal memory buffer of a NVM/SSD controller.

16. The method according to claim 15, wherein performing the block memory write to transfer the data from the data buffer region to the NAND/NVM page according the first write command comprises:
fetching the first write command from the CMD region; and
decoding the first write command for source point and NAND/NVM block logic unit number.

17. The method according to claim 16, further comprising setting data committed status to the status region when the data are transferred to a NAND/NVM device.

18. The method according to claim 17, further comprising:
merging data blocks to the NAND/NVM page;
writing the NAND/NVM page to the NAND/NVM device; and
updating a FTL region of the memory buffer.

19. A method comprising:
receiving a read command and descriptors at a CMD region of a memory buffer;
performing a block memory read to transfer data from a NVM/SSD page of a NVM/SSD device to a data buffer region of the memory buffer according to the read command;
polling for a NVM/SSD page read completion status at the NVM/SSD device register;
transferring the NVM/SSD page to the data buffer region as the NVM/SSD device status shows data ready;
setting the read completion status or an error message at the data buffer region to inform a host.

20. The method according to claim 19, wherein the memory buffer is an internal memory buffer of a NVM/SSD controller.
